(19) United States
(12) Patent Application Publication
(10) Pub. No.: US 2010/0250604 A1
(43) Pub. Date: Sep. 30, 2010

(54) Method for Processing Data Access in an Information Management System and Related Information Management System

(76) Inventors: Sen-Ta Chan, Taipei Hsien (TW); Chien-Shan Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/485,915

(22) Filed: Jun. 17, 2009

(30) Foreign Application Priority Data
Mar. 24, 2009 (TW) 098109605

(51) Int. Cl. G06F 17/30

(52) U.S. Cl. 707/782; 707/E17.032; 707/E17.005

(57) ABSTRACT

A method for processing data access in an information management system is disclosed. The information management system includes a plurality of servers and a database. According to the method, a user device connects to a first server. When an access command received from the user device cannot be processed by the first server, the first server writes a user data and an identification data of the user device into the database, and transmits a re-guide address including an address of a second server which can process the access command and the identification data to the user device. The second server retrieves the user data from the database according to the identification data included in the re-guide address, and replies a result of the access command to the user device according to the user data.

### BACKGROUND OF THE INVENTION

1. Field of the Invention

The present invention relates to a method and related information management system for processing data access in an information management system, and more particularly, to a method and related information management system for enhancing convenience.

2. Description of the Prior Art

With growth of enterprise organization, a single-site enterprise usually evolves into a multi-site enterprise, and may develop into a multinational organization. To manage production plan, manpower allocation, working progress, etc. in each site, such enterprise usually use an enterprise server to integrate or manage information of each site.

For example, please refer to FIG. 1, which is a schematic diagram of an information management system 10 utilized for a multi-site enterprise. In the information management system 10, user devices USR_1˜USR_n in different sites perform related management such as production plan, manpower allocation, working progress, etc. to access data of a server SVR according to different requirements via internet or intranet. However, as the number of user devices, namely “n”, increases, execution load of the server SVR rises, and may lead to an overload. To avoid this problem, execution ability of the server SVR must be upgraded, which solves the overload problem temporarily; the overload still happens once the number of the user devices increases. On the other hand, since the user devices USR_1˜USR_n access the server SVR via internet or intranet, service rate of the server SVR is affected by the execution load and also related to network environment or network speed. That is, if a distance between a user device USR_x and the server SVR is far or local network quality is low, the service rate provided by the server SVR is slower for the user device USR_x.

To improve disadvantages of a single server, the prior art further provides an information management system 20 shown in FIG. 2. The information management system 20 comprises servers SVR_1˜SVR_n in each site, and consequently the user devices USR_1˜USR_n can perform related management such as production plan, manpower allocation, working progress, etc. to access information of a local server according to different requirements via internet or intranet. Under such circumstances, the servers SVR_1˜SVR_n only need to serve local user devices to decrease the overload condition and enhance the service rate effectively. Besides, to ensure that the user devices USR_1˜USR_n can perform same functions via the corresponding servers, the servers SVR_1˜SVR_n need to perform synchronization, to synchronize data of the servers SVR_1˜SVR_n via duplication contents of databases thereof. However, “synchronization” is only performed for files in the databases, but not for files outside the databases. Besides, when data flow is huge, time and resource cost for performing synchronization becomes tremendous. In another prior art, synchronization is not performed, and the user device USR_x directly connects to a server SVR_y when the user device USR_x accesses data of the server SVR_y (a server other than a server SVR_x corresponding to the user device USR_x). The main disadvantage of such solution is that the user needs to perform login and logout among the servers, causing inconvenience.

Therefore, for the multi-server information management system, how to access every server easily and safely becomes a goal for the industry.

### SUMMARY OF THE INVENTION

It is therefore a primary objective of the claimed invention to provide a method for processing data access in an information management system and related information management system.

The present invention discloses a method for processing data access in an information management system having a plurality of servers and a database. The method comprises a user device connecting to a first server of the plurality of servers; the first server receiving an access command from the user device; when the access command is incapable of being processed by the first server, the first server writing a user data and an identification data of the user device into the database, and transmitting a re-guide address comprising an address of a second server capable of processing the access command in the plurality of servers and the identification data to the user device, for allowing the user device to connect to the second server; the second server retrieving the user data from the database according to the identification data of the re-guide address; and the second server replying a result of the access command to the user device according to the user data.

The present invention further discloses an information management system which comprises a database for storing data; a plurality of servers; and a plurality of programs stored in each of the plurality of servers. Each of the plurality of programs comprises a connecting unit for connecting to a first user device; an outputting unit for writing a user data and an identification data corresponding to the first user device into the database when a first access command outputted from the first user device is received while the first access command is incapable of being processed; a transmitting unit for transmitting a first re-guide address comprising an address of another server capable of processing the access command in the plurality of servers and the identification data to the first user device, for allowing the first user device to automatically connect to the another server; a reading unit for retrieving a user data corresponding to a second user device stored in the database according to an identification data of a second re-guide address when the second user device connects to the connecting unit according to the second re-guide address; and a replying unit for replying a result of a second access command to the second user device according to the user data of the second user device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an information management system in the prior art.

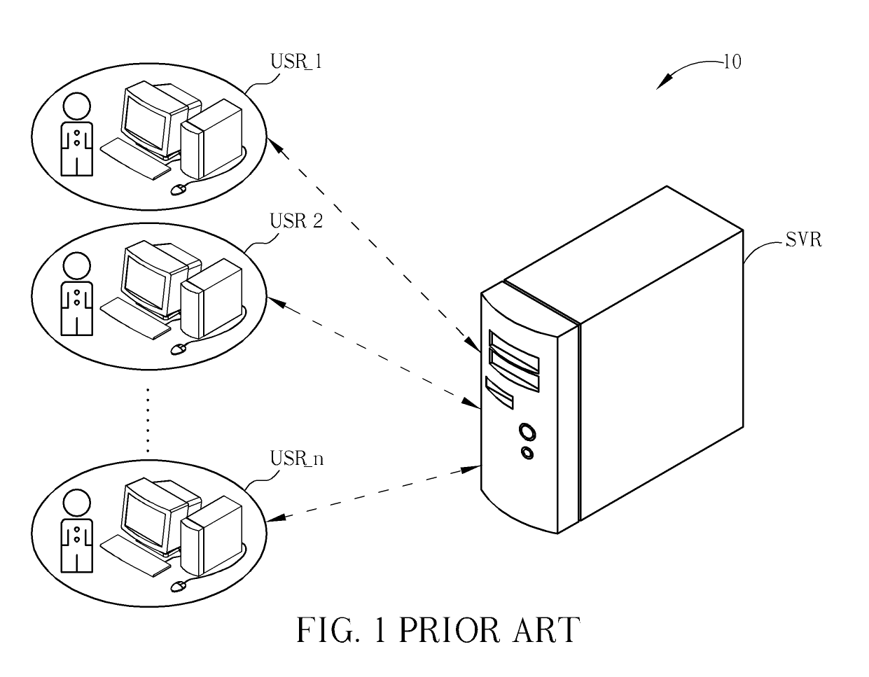

FIG. 2 is a schematic diagram of another information management system in the prior art.

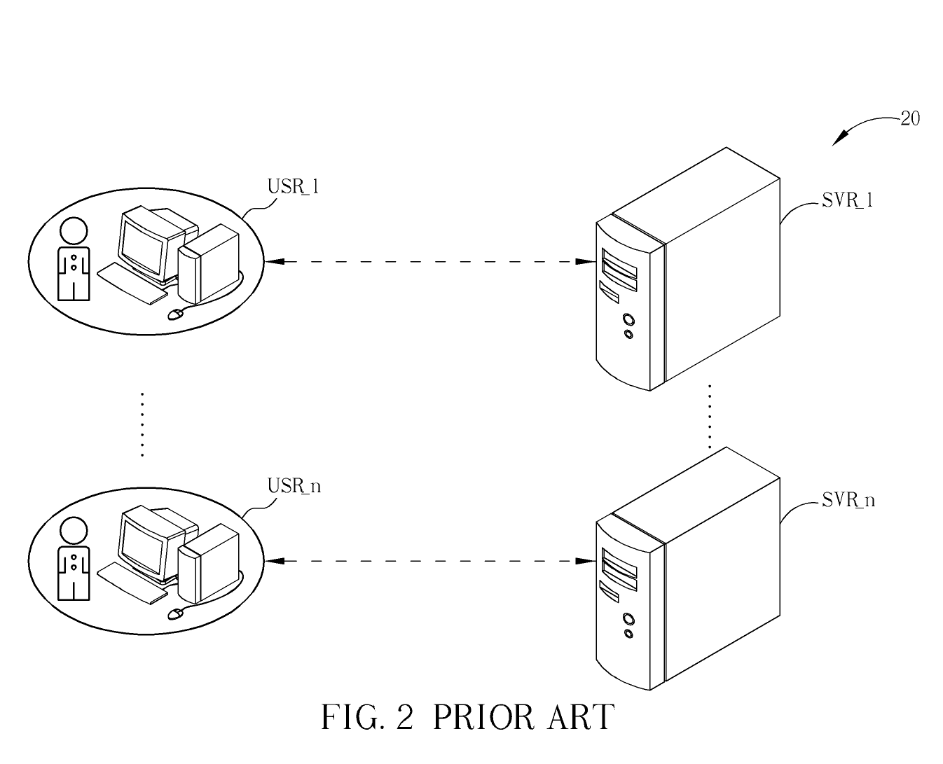

FIG. 3 is a schematic diagram of an information management system according to an embodiment of the present invention.

FIG. 4 is a schematic diagram of an operating process according to an embodiment of the present invention.

FIG. 5 is a schematic diagram of an operation of the information management system shown in FIG. 3.

FIG. 6 is a schematic diagram of a program according to an embodiment of the present invention.

### DETAILED DESCRIPTION

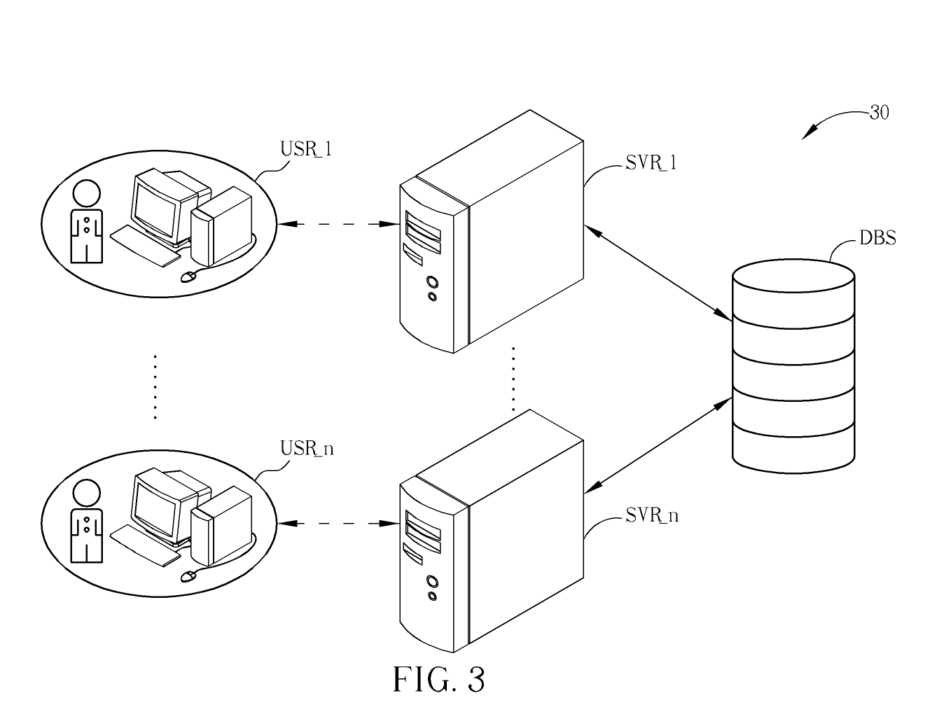

Please refer to FIG. 3, which is a schematic diagram of an information management system 30 according to an embodiment of the present invention. The information management system 30 is similar to the information management system 20, and is also composed of servers SVR_1˜SVR_n. The difference between the information management system 30 and the information management system 20 is that the information management system 30 adds a database DBS for storing data. In the information management system 30, when a user device USR_x of user devices USR_1˜USR_n needs to access data of a server SVR_y (other than a server SVR_x corresponding to the user device USR_x), the user device USR_x connects to the server SVR_x first and then the server SVR_x reguides the user device USR_x to the server SVR_y. During the process, a user of the user device USR_x does not need to enter login information (user account and password) again, because the database DBS temporarily stores related data, to effectively reguide the user device USR_x to the server SVR_y without information security concerns.

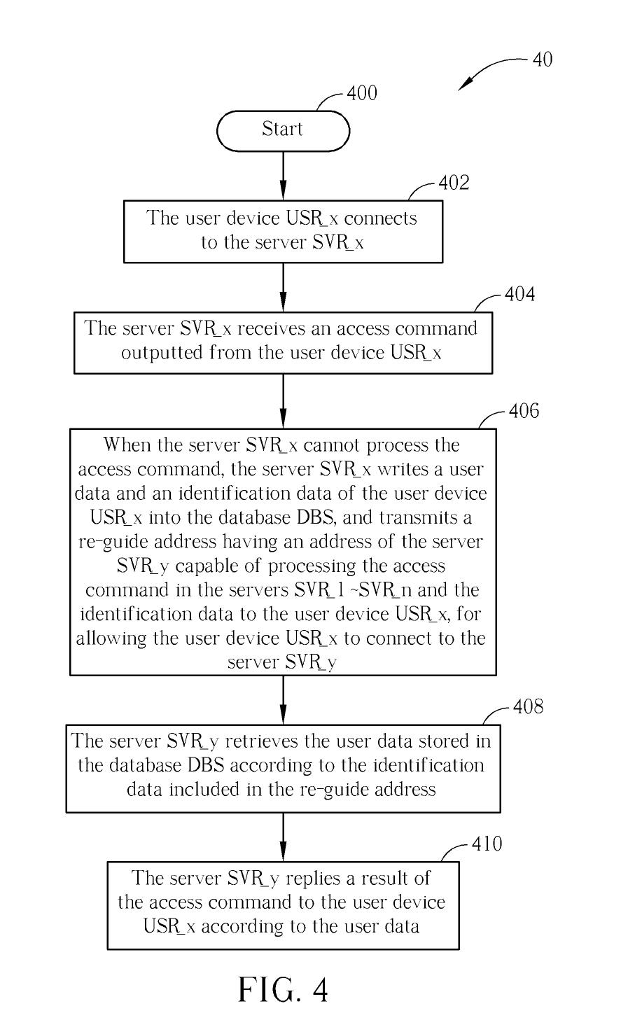

Please continue to refer to FIG. 4, which is a schematic diagram of a process 40 according to an embodiment of the present invention. The process 40 is utilized for processing data access in the information management system 30, and includes the following steps:

Step 400: Start.

Step 402: The user device USR_x connects to the server SVR_x.

Step 404: The server SVR_x receives an access command outputted from the user device USR_x.

Step 406: When the server SVR-x cannot process the access command, the server SVR_x writes a user data and an identification data of the user device USR_x into the database DBS, and transmits a re-guide address having an address of the server SVR_y capable of processing the access command in the servers SVR_1˜SVR_n and the identification data to the user device USR_x, for allowing the user device USR_x to connect to the server SVR_y.

Step 408: The server SVR_y retrieves the user data stored in the database DBS according to the identification data included in the re-guide address.

Step 410: The server SVR_y replies a result of the access command to the user device USR_x according to the user data.

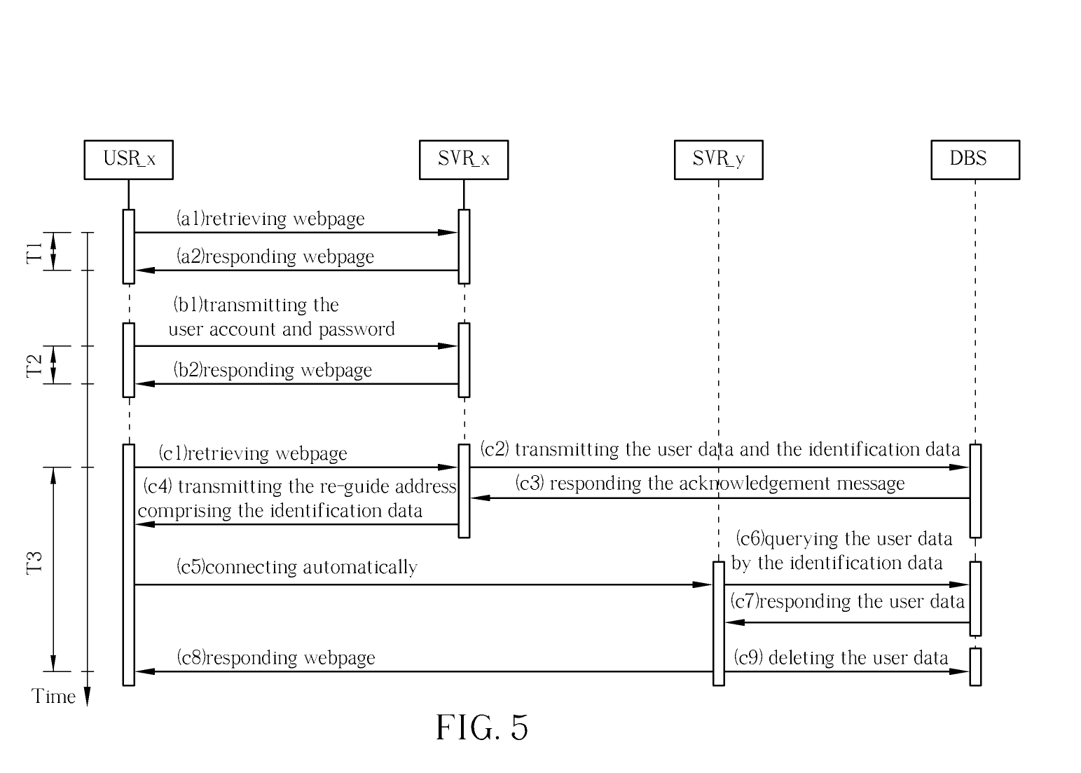

To clearly illustrate the process 40, please refer to FIG. 5 at the same time. In FIG. 5, steps (a1)˜(b2) correspond to the steps 402 and 404 of the process 40; steps (c1)˜(c5) correspond to the step 406 of the process 40; steps (c6) and (c7) correspond to the step 408 of the process 40; steps (c8) and (c9) correspond to the step 410 of the process 40. If the user of the user device USR_x needs to access the server SVR_y, then during a time interval T1, the user device USR_x tries to connect to the server SVR_x (step (a1)), and determines whether to connect to the SVR_x according to an acknowledgement message reported by the server SVR_x (step (a2)). If the user device USR_x can connect to the server SVR_x, then during time interval T2, the user device USR_x transmits user verification data (user account and password) to the server SVR_x to perform verification (step (b1)), and login the server SVR_x after verification success (step (b2)). Next, during time interval T3, when a command of the user device USR_x accessing the server SVR_y is received by the server SVR_x (step (c1)) while the command is incapable of being processed, the server SVR_x writes the user data and the identification data of the user device USR_x into the database DBS (step (c2)), and the database DBS replies whether the write-in action is successful (step (c3)). Then, the server SVR_x transmits the re-guide address including the address of the server SVR_y and the identification data of the user device USR_x to the user device USR_x (step (c4)), for allowing the user device USR_x to automatically connect to the server SVR_y (step (c5)). When the user device USR_x connects to the server SVR_y, the server SVR_y retrieves the user data of the user device USR_x from the database DBS according to the identification data of the re-guide address (step (c6) and (c7)). Finally, the server SVR_y determines requirements of the user device USR_x according to the user data stored in the database DBS, and replies requiring actions (step (c8)). Meanwhile, for enhancing information security, the server SVR_y can further delete the user data stored in the database DBS.

Simply speaking, in the information management system 30, when the user device USR_x connects to the server SVR_x, if the user device USR_x needs to access data of other server SVR_y (other than the corresponding server SVR_x), the server SVR_x writes the user data and the identification data of the user device USR_x into the database DBS and transmits the re-guide address to the user device USR_x, for allowing the user device USR_x to automatically connect to the server SVR_y. The re-guide address not only allows the user device USR_x to automatically connect to the server SVR_y, but also includes the identification data of the user device USR_x for performing the verification. Therefore, the server SVR_y can retrieve the corresponding user data in the database DBS via the identification information of the re-guide address, and determines user requirements to appropriately reply access progress. In other words, during the process that the server SVR x reguides the user device USR_x to the server SVR_y, the user of the user device USR_x does not need to enter login information (user account and password) again, but the database DBS stores related data temporarily instead to effectively reguide the user device USR_x to the server SVR_y without information security concerns.

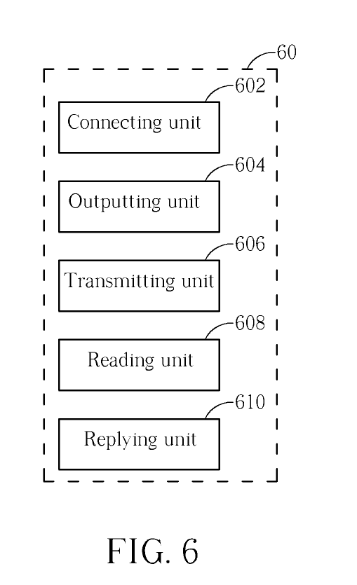

In the prior art information management system 20 having multiple servers, to avoid synchronization, the user needs to perform login and logout among the servers, which causes inconvenience. In comparison, the information management system 30 of the present invention does not need to perform synchronization, and furthermore the user only needs to login once (if required) to automatically transfer to other servers to access data. Therefore, the present invention can greatly enhance convenience. _As to realization of the information management system 30, the database DBS is added in the present information management system 20, and a program 60 is added in the servers SVR_˜SVR_n. Please refer to FIG. 6, which is a schematic diagram of the program 60. The program 60 comprises a connecting unit 602, an outputting unit 604, a transmitting unit 606, a reading unit 608, and a replying unit 610, for performing the steps 402, 404, 406, 408 and 410 of the process 40 respectively. For example, if the program 60 is stored in the server SVR_x, the connecting unit 602 is utilized for connecting to the user device USR_x. The outputting unit 604 is utilized for writing the user data and the identification data corresponding to the user device USR_x into the database DBS when the access command outputted from the user device USR_x is received while the access command is incapable of being processed. The transmitting unit 606 is utilized for transmitting the re-guide address to the user device USR_x, for allowing the user device USR_x to automatically connect to the server SVR_y capable of processing the access command. The reading unit 608 is utilized for retrieving a user data corresponding to a user device USR_z stored in the database DBS according to the identification data of the re-guide address when the user device USR_z automatically makes a connection. Finally, the replying unit 610 is utilized for replying a corresponding access result to the user device USR_z according to the user data of the user device USR_z. Simply speaking, the connecting unit 602, the outputting unit 604 and the transmitting unit 606 are utilized for processing connection and re-guide of the user device USR_x, and the reading unit 608 and the replying unit 610 are utilized for processing operations of another user device USR_z reguided to the server SVR_x.

To sum up, the present invention allows the user to login only one time (if required) to automatically transfer to other servers to access data. Therefore, the present invention can enhance convenience.

Those skilled in the art will readily observe that numerous modifications and alterations of the device and method may be made while retaining the teachings of the invention.

What is claimed is:

1. A method for processing data access in an information management system having a plurality of servers and a database, the method comprising:
a user device connecting to a first server of the plurality of servers;
the first server receiving an access command from the user device;
when the access command is incapable of being processed by the first server, the first server writing a user data and an identification data of the user device into the database, and transmitting a re-guide address comprising an address of a second server capable of processing the access command in the plurality of servers and the identification data to the user device, for allowing the user device to connect to the second server;
the second server retrieving the user data from the database according to the identification data of the re-guide address; and
the second server replying a result of the access command to the user device according to the user data.

2. The method of claim 1, wherein the user device connecting to the first server of the plurality of servers is the user device connecting to the first server after passing a verification of the first server.

3. The method of claim 2, wherein the second server does not execute the verification on the user device after the user device automatically connects to the second server.

4. The method of claim 1, wherein the second server replying the result of the access command to the user device according to the user data comprises:
the second server determining a requirement of the user device according to the user data; and
the second server replying the result of the access command to the user device according to the requirement of the user device.

5. The method of claim 4 further comprising the second server deleting the user data stored in the database.

6. An information management system comprising:
a database, for storing data;
a plurality of servers; and
a plurality of programs, stored in each of the plurality of servers, each of the plurality of programs comprising:
a connecting unit, for connecting to a first user device;
an outputting unit, for writing a user data and an identification data corresponding to the first user device into the database when a first access command outputted from the first user device is received while the first access command is incapable of being processed;
a transmitting unit, for transmitting a first re-guide address comprising an address of another server capable of processing the access command in the plurality of servers and the identification data to the first user device, for allowing the first user device to automatically connect to the another server;
a reading unit, for retrieving a user data corresponding to a second user device stored in the database according to an identification data of a second re-guide address when the second user device connects to the connecting unit according to the second re-guide address; and
a replying unit, for replying a result of a second access command to the second user device according to the user data of the second user device.

7. The information management system of claim 6, wherein the connecting unit connects to the first user device after the first user device passes a verification of the information management system.

8. The information management system of claim 7, wherein the connecting unit of the another server does not execute the verification on the first user device after the first user device automatically connects to the another server.

9. The information management system of claim 6, wherein the replying unit determines a requirement of the second user device according to the user data of the second user device, and replies the result of the second access command to the second user device according to the requirement of the second user device.
